(19) United States
(12) Patent Application Publication
(10) Pub. No.: US 2010/0134924 A1
(43) Pub. Date: Jun. 3, 2010

(54) STORAGE DEVICE

(75) Inventor: Hiroshi NAGATA, Ome-shi (JP)

Correspondence Address: KNOBBE MARTENS OLSON & BEAR LLP, 2040 MAIN STREET, FOURTEENTH FLOOR, IRVINE, CA, 92614, US

(73) Assignee: TOSHIBA STORAGE DEVICE CORPORATION, Tokyo (JP)

(21) Appl. No.: 12/700,407

(22) Filed: Feb. 4, 2010

Related U.S. Application Data
(63) Continuation of application No. PCT/JP2007/065373, filed on Aug. 6, 2007.

(51) Int. Cl. G11B 5/60

(52) U.S. Cl. 360/234; G9B/5.229

(57) ABSTRACT

According to one embodiment, a storage device includes at least one storage disk fixed to a hub mounted on a motor by a disk fixing mechanism, and a head configured to read and write information from and to the storage disk. The disk fixing mechanism includes a clamp ring, including a mounting hole on an inner peripheral side thereof through which the clamp ring is attached to the hub by a screw and a pressing portion for pressing the disk and a balance adjustment recess on an outer peripheral side thereof, and a balance wire attached to the balance adjustment recess. A first portion from the inner peripheral side to the pressing portion of the clamp ring and a second portion with the balance adjustment recess are formed of different materials.

### CROSS REFERENCE TO RELATED APPLICATIONS

This is a Continuation Application of PCT Application No. PCT/JP2007/065373, filed Aug. 6, 2007, which was published under PCT Article 21(2) in Japanese.

### BACKGROUND

1. Field

One embodiment of the invention relates to a storage device, and more specifically, to a storage device comprising a disk fixing mechanism for fixing a magnetic disk to a hub mounted on the shaft of a spindle motor.

2. Description of the Related Art

Usually, data preservation in computers is performed by external storage devices that can save data even when they are cut off from the power supply. While semiconductor memories, optical discs, magnetic disk drives, etc., may be used as these external storage devices, magnetic disk drives are popularly available because of their high capacity. Hard disk drives are prevailing magnetic disk drives that comprise a magnetic disk (hereinafter referred to as the disk) for data storage coated with a magnetic material and a magnetic head for reading and writing data from and to the disk. A disk used in a hard disk drive has a structure comprising a number of aluminum or glass disks coated with a magnetic material, and it is rotated at high speed by a spindle motor so that data can be read and written by the magnetic head.

One or more disks are mounted on the shaft of the spindle motor (hereinafter referred to as the motor), depending on the thickness of the hard disk drive. More specifically, this structure is configured so that the shaft of the motor is provided with a hub that rotates together with the shaft, and the disk is fixed to the motor in such a manner that it is held between the hub and a disk fixing mechanism. The disk fixing mechanism comprises a clamp ring that holds down the disk, screws that fix the clamp ring to the hub, and a balance wire (not shown). In the case where a plurality of disks are mounted on the motor, the disk fixing mechanism includes a spacer ring or rings sandwiched between the disks 4.

The disk fixing mechanism needs to fix the disk to the motor with a force that prevents the disk from being dislocated by an external impact. Further, the disk should be free from deformation, such as warp, when it is fixed to the motor, and the hub and disk fixing mechanism require rigidity. Thus, the clamp ring of the disk fixing mechanism used to be manufactured from a highly rigid metallic material.

On the other hand, the disk mounted on the hub by the disk fixing mechanism vibrates if unbalanced as it is rotated by the motor, whereupon the accuracy of data reading by the magnetic head is reduced. The rotating body is thus unbalanced depending on variation in the weight of the disk fixing mechanism that constitutes the rotating body, dimensions of the rotating body, or motor operation. Thereupon, in order to remove the unbalance, a balance adjustment recess is disposed in the outer peripheral portion of the clamp ring, and a balance wire is inserted into this balance adjustment recess.

Since the entire clamp ring is formed of rigid metal, however, the disk fixing mechanism constructed in this manner is heavy, and the balance adjustment recess in the outer peripheral portion of the clamp ring has too complicated a shape to be easily worked. In order to solve the problem of the weight of the clamp ring, the clamp ring may be formed of a composite material, such as fiberglass or carbon fiber, in place of the metallic material, as described in Jpn. Pat. Appln. KOKAI Publication No. 4-105280 (number 6 in FIG. 1).

The clamp ring disclosed in Patent Document 1 can be formed of a composite material because of its shape that does not require a balance adjustment recess for a balance wire in its outer peripheral portion. However, it cannot be adopted if the balance adjustment recess is required in the outer peripheral portion.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1A is an exemplary plan view showing a configuration of a hard disk drive comprising a disk fixing mechanism of the present invention, and FIG. 1B is a sectional view corresponding to FIG. 1A;

FIG. 2A is an exemplary partially enlarged plan view of the disk fixing mechanism shown in FIG. 1A, FIG. 2B is a sectional view of a clamp ring used in a conventional disk fixing mechanism, and FIG. 2C is a sectional view of a clamp ring according to one embodiment of the present invention used in the disk fixing mechanism;

FIG. 3A is an exemplary partially enlarged sectional view of a portion where a disk is fixed to a spindle motor by means of the conventional disk fixing mechanism, and FIG. 3B is a partially enlarged sectional view of a portion where the disk is fixed to the spindle motor by means of the disk fixing mechanism according to the one embodiment of the present invention;

FIGS. 4A, 4B, 4C and 4D are exemplary views showing processes in which the clamp ring shown in FIG. 2C is manufactured by insert molding;

FIGS. 5A, 5B, 5C, and 5D are exemplary partially enlarged sectional views showing configurations of clamp rings according to second to fifth embodiments of the present invention; and

FIG. 6A is an exemplary partially enlarged plan view showing a clamp ring according to a sixth embodiment of the present invention, FIG. 6B is an exemplary sectional view corresponding to FIG. 6A, and FIG. 6C is an exemplary partially enlarged plan view showing a modification of the clamp ring of the sixth embodiment of the invention shown in FIG. 6A.

### DETAILED DESCRIPTION

Various embodiments according to the invention will be described hereinafter with reference to the accompanying drawings. In general, according to one embodiment of the invention, there is provided a storage device configured to read and write information from and to at least one storage disk rotated by a motor by means of a head disposed on a distal end of a swing arm, the storage disk being fixed to a hub mounted on the motor by a disk fixing mechanism, wherein the disk fixing mechanism comprises a clamp ring, comprising a mounting hole on an inner peripheral side thereof through which the clamp ring is attached to the hub by a screw and a pressing portion for pressing the disk and a balance adjustment recess on an outer peripheral side thereof, and a balance wire attached to the balance adjustment recess, and a first portion from the inner peripheral side to the pressing portion of the clamp ring and a second portion of the balance adjustment recess are formed of different materials.

According to one embodiment of the invention, there is provided a disk fixing mechanism for fixing a disk mounted in a storage device to a hub, comprising a clamp ring, which comprises a mounting hole on an inner peripheral side thereof through which the clamp ring is attached to the hub by a screw and a pressing portion for pressing the disk and a balance adjustment recess on an outer peripheral side thereof, and a balance wire attached to the balance adjustment recess, wherein a first portion from the inner peripheral side to the pressing portion of the clamp ring and a second portion of the balance adjustment recess are formed of different materials.

The first and second portions may be formed of stainless steel and synthetic resin, respectively, the stainless steel and synthetic resin being joined to each other by insert molding. Alternatively, the first and second portions may be formed of stainless steel and aluminum, respectively, the stainless steel and aluminum being joined to each other by insert molding.

According to the embodiment, the second portion of the balance adjustment recess into which the balance wire is inserted is formed of a highly moldable, workable material, so that working the balance adjustment recess part can be eased, the production man-hours for the clamp ring can be reduced, and hence, costs can be reduced.

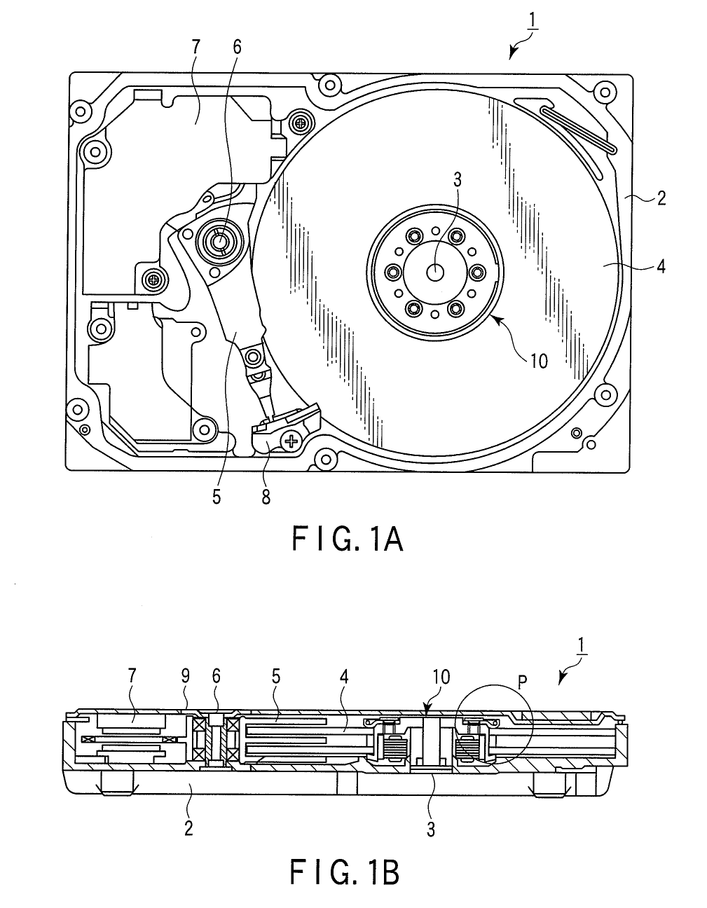

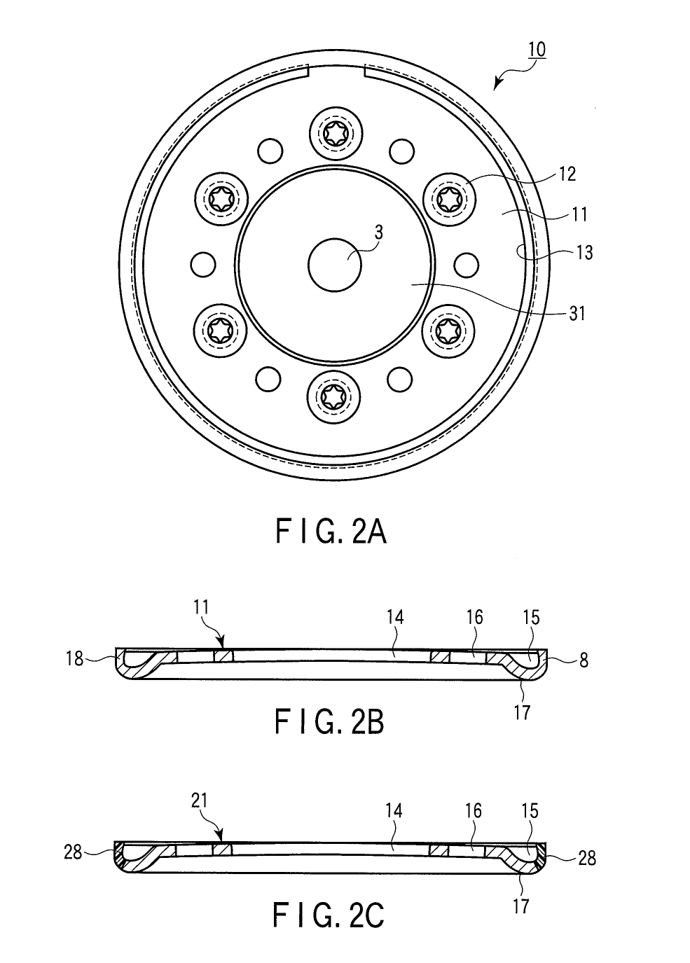

Embodiments of the present invention will now be described with reference to the drawings. Before describing the embodiments of the present invention, a configuration of a hard disk drive to which the present invention is applied will be described with reference to FIGS. 1A and 1B, and a configuration and problems of a conventional disk fixing mechanism will be described with reference to FIGS. 2A and 2B.

FIGS. 1A and 1B are a plan view and sectional view, respectively, showing a hard disk drive 1 as a load/unload-type example to which the present invention is applied. At least one disk (magnetic disk) 4 for use as a storage medium, which is rotated by a motor (spindle motor) 3, is located over one side of a base 2 of the hard disk drive 1. This disk 4 has a large number of tracks for data recording. The disk 4 is mounted on the motor 3 by a disk fixing mechanism 10 and is rotated by the motor 3.

A swing arm 5 is located over the other side of the base 2 of the hard disk drive 1. The swing arm 5 is provided with a head (not shown), which accesses the tracks of the disk 4 to read and write data. The head is mounted on the distal end of the swing arm 5. The swing arm 5 is configured to swing around a pivot 6, and a voice coil motor 7 for driving the swing arm 5 is disposed on the opposite side of the pivot 6 from the swing arm 5. A top opening of the base 2 of the hard disk drive 1 is covered by a cover 9, as shown in FIG. 1B.

In the load/unload hard disk drive 1, moreover, the head is retracted to the outside of the disk 4 in an unloading mode. To attain this, the load/unload hard disk drive 1 is provided with a ramp mechanism 8, which is located on the base 2 near the outer periphery of the disk 4 and serves to hold the distal end of the swing arm 5. The ramp mechanism 8 holds the head in such a manner that a part called a lift tab on the distal end of the swing arm 5 is caused to run onto a wedged ramp member.

FIG. 2A enlargedly shows the disk fixing mechanism 10 shown in FIG. 1A. The disk fixing mechanism 10 comprises a clamp ring 11, screws 12, and balance wire 13. FIG. 2B shows a profile of the clamp ring 11 as a simple. The clamp ring 11, which is an annular flat plate comprising an aperture 14 in the center, has its outer peripheral edge curved, and the outer peripheral surface of this curved portion forms a pressing portion 17 that presses the disk 4. An annular balance adjustment recess 15 into which the balance wire 13 is to be inserted is defined in a part inside the pressing portion 17. An outer peripheral portion 18 outside the balance adjustment recess 15 of the clamp ring 11 has a complicated shape, projecting toward the center to mitigate the risk of the balance wire 13 in the balance adjustment recess 15 slip out. Further, threaded holes 16 through which the clamp ring 11 is fixed to a hub (mentioned later) by the screws 12 dare formed at predetermined intervals in a concentric circle near the inner periphery of the clamp ring 11.

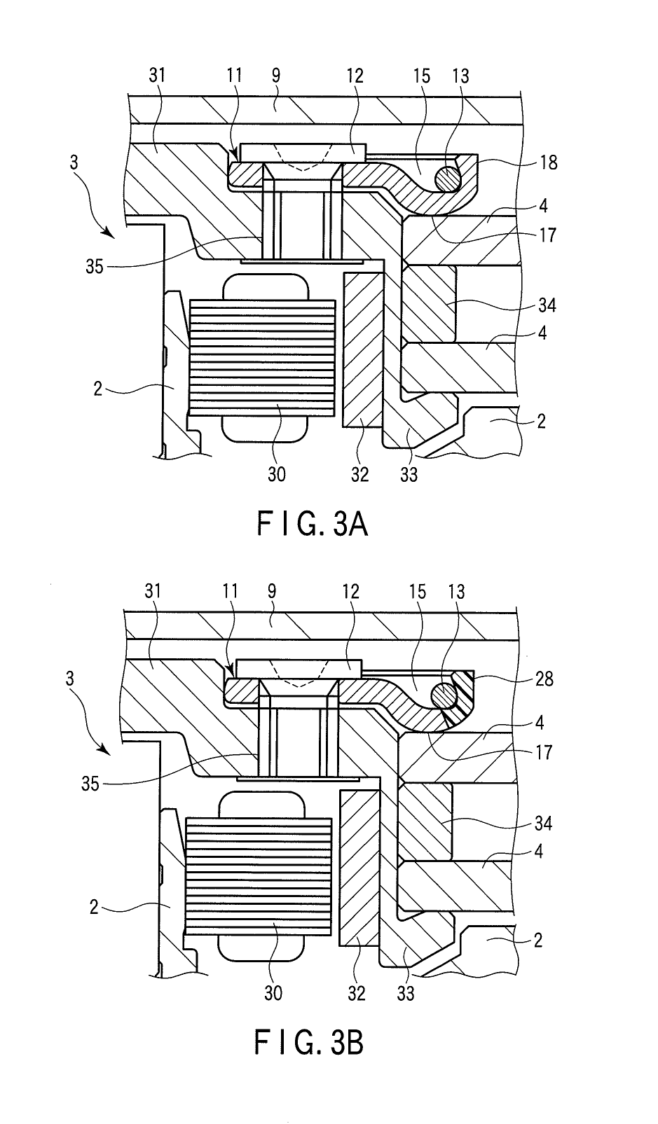

FIG. 3A enlargedly shows a portion designated by symbol P in FIG. 1B. FIG. 3A shows a detailed configuration of a mounting portion for the disk 4 to be mounted on the motor 3. The motor 3 comprises a stator coil 30 fixed to the base 2, hub 31 rotatable integrally with the shaft of the motor 3, and magnet 32 attached to the inner peripheral surface of the hub 31. A flange portion 33 is formed on a free end portion of the hub 31. In this example, two disks 4 are fitted on the flange portion 33 with a spacer ring 34 between them. The two disks 4 are mounted on the hub 31 in such a manner that they are sandwiched between the flange portion 33 and the clamp ring 11 that is attached by the screws 12 to the threaded holes in the upper surface of the hub 31. The pressing portion 17 of the clamp ring 11 engages with the disks 4. Further, the balance wire 13 is fitted in the balance adjustment recess 15 of the clamp ring 11. Number 9 denotes the cover.

In the configuration described above, the conventional clamp ring 11 shown in FIGS. 2B and 3A is firmly mounted on the hub 31 by the screws 12, and the disks 4, along with the spacer ring 34, are sandwiched between the pressing portion 17 and flange portion 33. To this end, the clamp ring 11 is integrally formed of a highly rigid metallic material, e.g., stainless steel. Therefore, the outer peripheral portion 18 located outside the balance adjustment recess 15, which is expected only to receive the insertion of the balance wire 13 and does not need to be rigid, is also formed of a highly rigid metallic material. The thinner the clamp ring 11 of the disks in the future, on the other hand, the more rigid the metal to be used for the manufacture of the clamp ring 11 will be. Thus, there is a problem that the outer peripheral portion 18 of the clamp ring 11 with the complicated shape cannot be easily worked.

The present invention has been made in consideration of the fact that the outer peripheral portion 18 of the complicatedly shaped clamp ring 11, which is located outside an inserted part of the balance wire 13, does not need to be rigid. FIGS. 2C and 3B show a clamp ring 21 according to a first embodiment of the present invention. FIG. 2C shows the same part as FIG. 2B, while FIG. 3B shows the same part as FIG. 3A. Therefore, like numbers refer to like constituent members, and a description thereof is omitted.

The clamp ring 21 of the present invention differs from the conventional clamp ring 11 in that it is configured so that a first portion from the inner peripheral side to a pressing portion of the clamp ring and a second portion of the balance adjustment recess are formed of different materials, while the entire conventional clamp ring 11 is formed of one material. More specifically, an outer peripheral portion 28 of the clamp ring 21 of the present invention is formed of a nonrigid, highly workable synthetic resin, while the outer peripheral portion 18 of the conventional clamp ring 11 located outside the balance adjustment recess 15, which is expected only to receive the insertion of the balance wire 13 and does not need to be rigid, is also formed of the highly rigid metallic material. Workability depends on machinability (based on various conditions such as material hardness) in cutting operation and on moldability (based on various conditions such as material fluidity) in molding operation. The clamp ring 21 according to the present invention can be formed by insert molding after its entire body except the outer peripheral portion 28 is molded by pressing.

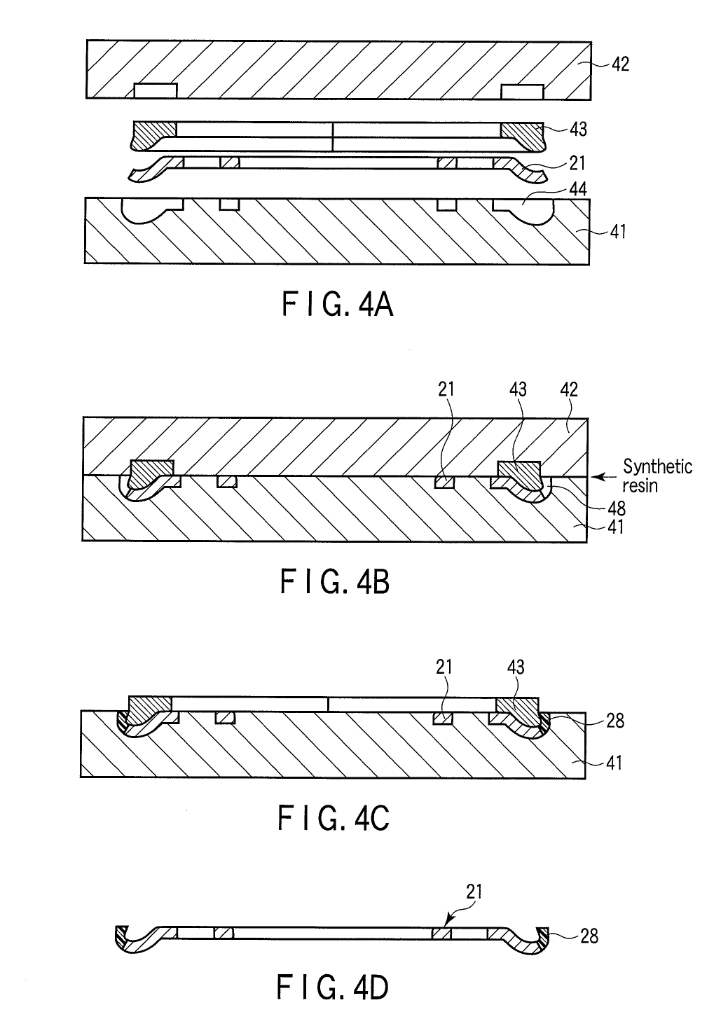

FIGS. 4A to 4D show processes in which the clamp ring 21 of the present invention is formed by insert molding. As shown in FIG. 4A, a female die 41 comprises a cavity 44 with a contour on the hub side of the clamp ring 21, and the clamp ring 21 without the outer peripheral portion 28 that is molded by pressing is inserted into the cavity. A divisible core 43 is fitted into a male die 42 and mated with the female die 41, as shown in FIG. 4B. In this state, the cavity 48 exists only in a part corresponding to the outer peripheral portion 28 of the clamp ring 21, and the synthetic resin is injected into the cavity 48.

After the injection of the synthetic resin, if the male die 42 is disengaged, as shown in FIG. 4C, and if the core 43 is decomposed and removed, the clamp ring 21 of the present invention with its outer peripheral portion 28 formed of the synthetic resin can be manufactured, as shown in FIG. 4D. Although the synthetic resin is injected into the cavity 48 of the female die 41 according to this embodiment, the outer peripheral portion 28 may also be formed by injecting a highly workable metallic material such as aluminum.

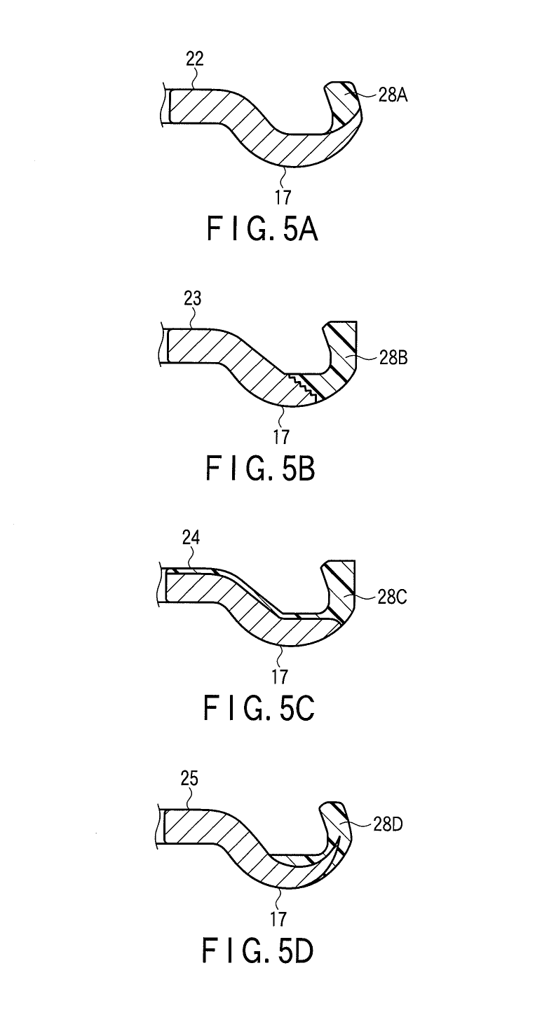

FIGS. 5A to 5D show configurations of clamp rings 22 to 25 according to second to fifth embodiments of the present invention. In the clamp ring 22 of the second embodiment shown in FIG. 5A, the thickness of the clamp ring 22 outside a pressing portion 17 is gradually reduced by shaving the upper surface, and an outer peripheral portion 28A of the synthetic resin is formed only on its distal end portion. In the clamp ring 23 of the third embodiment shown in FIG. 5B, the clamp ring 23 outside a pressing portion 17 is cut stepwise, and an outer peripheral portion 28B of the synthetic resin is formed outside the cut part. In the clamp ring 24 of the fourth embodiment shown in FIG. 5C, the clamp ring 24 outside a pressing portion 17 is cut substantially horizontally, an outer peripheral portion 28C of the synthetic resin is formed outside the cut part, and the synthetic resin is disposed so as to be laminated to the upper surface of the clamp ring 24. In the clamp ring 25 of the fifth embodiment shown in FIG. 5D, the thickness of the clamp ring 25 outside a pressing portion 17 is gradually reduced by shaving both surfaces, and an outer peripheral portion 28D of the synthetic resin is formed on both sides of its distal end portion.

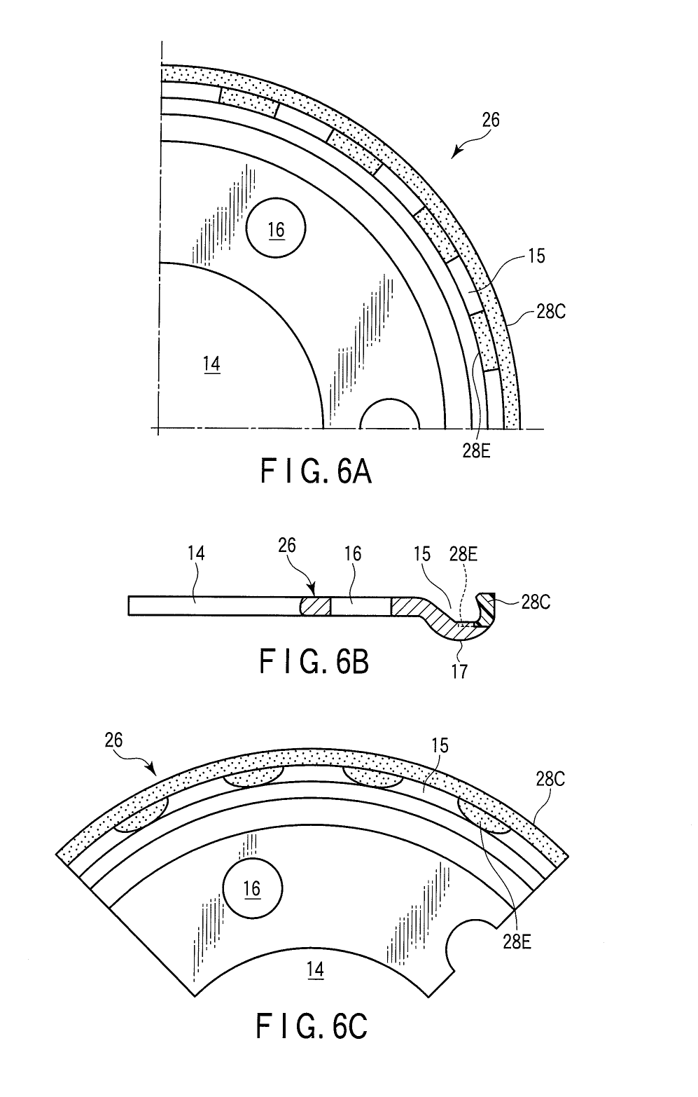

FIGS. 6A and 6B show a configuration of a clamp ring 26 of a sixth embodiment of the present invention. The sixth embodiment is a modification of the clamp ring 24 of the fourth embodiment shown in FIG. 5C. In the fourth embodiment, the clamp ring 24 outside the pressing portion 17 is cut substantially horizontally, the outer peripheral portion 28C of the synthetic resin is formed outside the cut part, and the synthetic resin is disposed so as to be laminated to the entire upper surface of the clamp ring 24. In the clamp ring 26 of the sixth embodiment, on the other hand, the clamp ring 26 outside the pressing portion 17 is cut substantially horizontally with a level difference, and the outer peripheral portion 28C of the synthetic resin is formed outside the cut part. A difference lies in that extended portions 28E are formed, thereafter, extending so that only inner peripheral parts of the synthetic resin fill shaved parts of the bottom surface of a balance adjustment recess 15 that is shaved for a predetermined length at predetermined intervals. The bottom surface of the balance adjustment recess 15 is a flat surface on which the metallic material and synthetic resin are arranged alternately.

FIG. 6C shows a modification of the clamp ring 26 of the sixth embodiment, which is different in that the extended portions 28E are not rectangular but circularly arcuate when viewed vertically from above. The shape of the extended portions 28E is not limited to those of these embodiments, and extended portions 28E of any shapes can be formed by changing the die shape.

While certain embodiments of the invention have been described, these embodiments have been presented by way of example only, and are not intended to limit the scope of the invention. Indeed, the novel methods and systems described herein may be embodied in a variety of other forms. Furthermore, various omissions, substitutions and changes in the form of the methods and systems described herein may be made without departing from the spirit of the invention. The accompanying claims and their equivalents are intended to cover such forms or modifications as would fall within the scope and spirit of the invention.

What is claimed is:

1. A storage device comprising:
at least one storage disk configured to be rotated by a motor, the storage disk being attached to a hub on the motor by a disk attachment; and
a head on a distal end of a swing arm and configured to read information from the storage disk and to write information to the storage disk,
wherein the disk attachment comprises:
a clamp ring comprising
an attaching hole on an inner peripheral side of the clamp ring, the attaching hole configured to receive a screw in such a manner that the clamp ring is attached to the hub, and
a pressing portion configured to press the disk and a balance adjustment recess on the outer peripheral side of the clamp ring, and
a balance wire attached to the balance adjustment recess,
and wherein the clamp ring comprises a first portion from the inner peripheral side to the pressing portion of the clamp ring, and a second portion with the balance adjustment recess, the first portion and the second portion comprising different materials.

2. The storage device of claim 1, wherein an outer peripheral end portion of the first portion is thin-walled, and the second portion is attached onto the thin-walled portion.

3. The storage device of claim 1, wherein the second portion is laminated onto a surface of the first portion on a side opposite from the disk.

4. The storage device of claim 1, wherein a portion on the inner peripheral side of the second portion is extended to the surface of the first portion on the side opposite from the disk for a predetermined length at predetermined intervals.

5. The storage device of claim 1, wherein the first and second portions comprise stainless steel and synthetic resin, respectively, the stainless steel and synthetic resin being attached to each other by insert molding.

6. The storage device of claim 1, wherein the first and second portions comprise stainless steel and aluminum, respectively, the stainless steel and aluminum being attached to each other by insert molding.

7. A disk attachment for attaching a disk in a storage device to a hub, comprising:
a clamp ring comprising an attaching hole on an inner peripheral side of the clamp ring, the attaching hole configured to receive a screw in such a manner that the clamp ring is attached to the hub, and
a pressing portion configured to press the disk and a balance adjustment recess on an outer peripheral side of the clamp ring; and
a balance wire attached to the balance adjustment recess,
wherein the clamp ring comprises a first portion from the inner peripheral side to the pressing portion of the clamp ring, and a second portion with the balance adjustment recess, the first portion and the second portion comprising different materials.

8. The disk attachment of claim 7, wherein an outer peripheral end portion of the first portion is thin-walled, and the second portion is attached onto the thin-walled portion.

9. The disk attachment of claim 7, wherein the second portion is laminated onto a surface of the first portion on a side opposite from the disk.

10. The disk attachment of claim 7, wherein a portion on the inner peripheral side of the second portion is extended to the surface of the first portion on the side opposite from the disk for a predetermined length at predetermined intervals.

11. The disk attachment of claim 7, wherein the first and second portions comprise stainless steel and synthetic resin, respectively, the stainless steel and synthetic resin being attached to each other by insert molding.

12. The disk attachment of claim 7, wherein the first and second portions comprise stainless steel and aluminum, respectively, the stainless steel and aluminum being attached to each other by insert molding.
